(19) United States
(12) Patent Application Publication
(10) Pub. No.: US 2020/0384397 A1
(43) Pub. Date: Dec. 10, 2020

(54) Filtration Body Using Layered Double Hydroxide and Method for Manufacturing Said Filtration Body

(71) Applicant: JDC Corporation, Minato-ku, Tokyo (JP)

(72) Inventors: Mutsuhiro Ohno, Minato-ku, Tokyo (JP); Yutaka Kobayashi, Minato-ku, Tokyo (JP); Takeo Asakura, Minato-ku, Tokyo (JP)

(21) Appl. No.: 16/473,949

(22) PCT Filed: Dec. 27, 2017
(86) PCT No.: PCT/JP2017/046944

§ 371 Date: Sep. 11, 2019

(30) Foreign Application Priority Data
Dec. 27, 2016 (JP) 2016-253377
Dec. 27, 2016 (JP) 2016-253378

(51) Int. Cl. B01D 39/16; B01J 20/28; D06M 11/36

(52) U.S. Cl. CPC B01D 39/163; B01J 20/28023; D06M 11/36; B01D 2239/125; B01D 2239/0407; B01D 2239/0668; B01D 2239/10; B01J 20/2803

(57) ABSTRACT

An object is to provide a filtration body capable of uniformizing the distribution of a layered double hydroxide in the filtration body and also preventing the surface of the layered double hydroxide from being covered with a binder or the like, thereby making it possible to improve the conventional filtration efficiency, and also a method for producing the same. The filtration body is formed of a layered double hydroxide having a crystallite size of 20 nm or less carried on a carrier including a thermally fusible fiber.

### CROSS REFERENCE TO RELATED APPLICATIONS

This application claims priority to Japanese Patent Application No. 2016-253377 and Japanese Patent Application No. 2016-253378, each filed Dec. 27, 2016, and each of which is herein incorporated by reference in its entirety.

### TECHNICAL FIELD

The present invention relates to a filtration body formed of a layered double hydroxide carried on a carrier including a thermally fusible fiber, and also to a method for producing the same.

### BACKGROUND

A layered double hydroxide, such as hydrotalcite, is structured such that various ions, molecules, and the like can be intercalated between layers, allowing for the development of an anion exchange ability. Therefore, layered double hydroxides have been utilized in filtration bodies that adsorb and remove harmful substances and the like, for example.

Conventionally, as a filtration body using a layered double hydroxide, for example, a filtration body obtained by blending a binder with a powder of a layered double hydroxide, and molding the blend (see, e.g., U.S. Pat. No. 4,709,498), or a filtration body obtained by filling a column with granules of a layered double hydroxide prepared using a granulator or the like (see, e.g., U.S. Pat. No. 5,363,817) is known.

Meanwhile, as a filtration body using activated carbon, a filtration body in which a thermally fusible fiber serves as a carrier, and fibers or particles of activated carbon are attached to the surface of the fiber that has been fused by heating, is known (see, e.g., U.S. Pat. Nos. 1,938,657 and 2,986,054).

### BRIEF SUMMARY

However, a conventional filtration body using a layered double hydroxide has a problem in that the distribution of the layered double hydroxide in the filtration body is non-uniform, such as the case where a powder or granules of the layered double hydroxide concentrate in a lower part of the filtration body, for example. In addition, there also has been a problem in that in the case where a binder is blended, the surface of a powder or granules of the layered double hydroxide is covered with the binder, resulting in the deterioration of properties as a layered double hydroxide. Accordingly, a conventional filtration body using a layered double hydroxide has low filtration efficiency.

Thus, an object of the present invention is to provide a filtration body capable of uniformizing the distribution of a layered double hydroxide in the filtration body and also preventing the surface of the layered double hydroxide from being covered with a binder or the like, thereby making it possible to improve the conventional filtration efficiency, and also a method for producing the same.

In order to achieve the above object, the filtration body of the prevent invention is characterized by being formed of a layered double hydroxide having a crystallite size of 20 nm or less carried on a carrier including a thermally fusible fiber.

In this case, the thermally fusible fiber may be a two-layer conjugate fiber formed of a high-melting-point fiber coated with a low-melting-point fiber.

In addition, the carrier including a thermally fusible fiber may be in the form of short cut pieces or reticulated.

In addition, in the case where the carrier is reticulated, the filtration body may be configured such that a layered double hydroxide that cannot pass the mesh of the reticulated carrier is carried.

In addition, it is preferable that the layered double hydroxide has a specific surface area of 20 m²/g or more, more preferably a specific surface area of 70 m²/g or more.

In addition, it is preferable that the layered double hydroxide is in the form of granules produced by applying a predetermined pressure to a material containing a layered double hydroxide and water to remove moisture to a moisture content of 70% or less, followed by drying under conditions having a temperature of 90° C. or more and 110° C. or less.

In addition, the method for producing a filtration body of the present invention is a method for producing a filtration body formed of a layered double hydroxide carried on a reticulated carrier including a thermally fusible fiber. he method for producing a filtration body includes: a mounting step of mounting a layered double hydroxide on the reticulated carrier; and, after the mounting step, an attaching step of attaching the mounted layered double hydroxide to the reticulated carrier by thermally fusing the thermally fusible fiber.

In this case, the method may be configured such that the reticulated carrier is obtained by sequentially laminating a plurality of kinds of carriers having different mesh sizes in such a manner that a carrier having a larger mesh size is placed in an upper part, and, in the mounting step, a layered double hydroxide is supplied to an uppermost part of the laminated reticulated carriers, and the reticulated carriers are shaken until the layered double hydroxide is mounted on a lowermost part of the reticulated carriers.

According to the present invention, the distribution of a layered double hydroxide in the filtration body can be uniformized, and further, the surface of the layered double hydroxide can be prevented from being covered with a binder or the like. As a result, the filtration body of the present invention has lower filtration resistance than before, and also the properties of the layered double hydroxide are sufficiently exhibited.

### BRIEF DESCRIPTION OF DRAWINGS

FIG. 1 is a partial side view showing a part of the filtration body of the present invention.

FIG. 2 is a partial perspective view showing a part of the filtration body of the present invention.

FIG. 3 is a partial side view showing a part of the filtration body of the present invention.

FIG. 4 is a partial decomposed perspective view showing a part of the filtration body of the present invention.

FIG. 5 is a partial side view showing a part of the filtration body of the present invention.

### DETAILED DESCRIPTION

The filtration body of the present invention is characterized by being formed of a layered double hydroxide having a crystallite size of 20 nm or less carried on a carrier including a thermally fusible fiber.

First, a layered double hydroxide used in the filtration body of the present invention and a method for producing the same will be described.

A layered double hydroxide is a non-stoichiometric compound represented by general formula M²⁺₁₋ₓM³⁺ₓ(OH)₂(Aⁿ⁻)_{x/n}.mH₂O (wherein M²⁺ is a divalent metal ion, M³⁺ is a trivalent metal ion, Aⁿ⁻ is an anion, ⅙<x<⅓, and m and n are positive integers), and is sometimes referred to as a hydrotalcite-like compound. Examples of divalent metal ions (M²⁺) include Mg²⁺, Fe²⁺, Zn²⁺, Ca²⁺, Li²⁺, Ni²⁺, Co²⁺, and Cu²⁺. In addition, examples of trivalent metal ions (M³⁺) include Al³⁺, Fe³⁺, Cr³⁺, and Mn³⁺. In addition, examples of anions (Aⁿ⁻) include ClO₄⁻, CO₃²⁻, HCO₃⁻, PO₄³⁻, SO₄²⁻, SiO₄⁴⁻, OH⁻, Cl⁻, NO₂⁻, and NO₃⁻.

In the layered double hydroxide used in the filtration body of the present invention, any divalent metal ions (M²⁺), trivalent metal ions (M³⁺), and anions (Aⁿ⁻) may be used. In addition, in the layered double hydroxide, the stacking style of hydroxide layer sheets may be a rhombohedral structure or a hexagonal structure.

In addition, the layered double hydroxide used in the filtration body of the present invention has a crystallite size of 20 nm or less, preferably 10 nm or less. In addition, the average crystallite size is preferably 10 nm or less.

In addition, the specific surface area of the layered double hydroxide used in the filtration body of the present invention is not particularly limited, and the specific surface area by the BET method may be 20 m²/g or more, preferably 30 m²/g or more, still more preferably 50 m²/g or more, and still more preferably 70 m²/g or more. The upper limit of the specific surface area is not particularly limited. Incidentally, the specific surface area by the BET method can be determined, for example, by measuring the nitrogen adsorption-desorption isotherm using a specific surface area/pore distribution analyzer, and preparing a BET-plot from the measurement results.

In addition, the layered double hydroxide used in the filtration body of the present invention may be a calcined product of a layered double hydroxide. The calcined product can be obtained, for example, by calcining a layered double hydroxide at about 500° C. or more.

Hereinafter, a specific method for producing the layered double hydroxide used in the filtration body of the present invention will be described.

For example, a layered double hydroxide represented by general formula Mg²⁺₁₋ₓAl³⁺ₓ(OH)₂(Aⁿ⁻)_{x/n}.mH₂O(Aⁿ⁻ is an n-valent anion, and m>0) can be produced by the following method.

First, an acidic solution containing aluminum ions and magnesium ions is prepared.

The aluminum source of aluminum ions is not limited to a specific substance as long as it generates aluminum ions in water. For example, it is possible to use alumina, sodium aluminate, aluminum hydroxide, aluminum chloride, aluminum nitrate, bauxite, a residue of alumina production from bauxite, aluminum sludge, and the like. In addition, these aluminum sources may be used alone, and it is also possible to use a combination of two or more kinds.

In addition, the magnesium source of magnesium ions is not limited to a specific substance as long as it generates magnesium ions in water. For example, it is possible to use brucite, magnesium hydroxide, magnesite, a calcined product of magnesite, and the like. These magnesium sources may be used alone, and it is also possible to use a combination of two or more kinds.

Incidentally, the aluminum compound as an aluminum source and the magnesium compound as a magnesium source do not have to be completely dissolved as long as aluminum ions and magnesium ions are present in the acidic solution.

In addition, it is known that in a highly crystalline layered double hydroxide represented by Mg²⁺₁₋ₓAl³⁺ₓ(OH)₂(Aⁿ⁻)_{x/n}.mH₂O, the molar ratio between aluminum ions and magnesium ions is 1:3 (x=0.25). Therefore, the molar ratio between aluminum ions and magnesium ion in the acidic solution is preferably within a range of 1:5 to 1:2. When the molar ratio is within this range, without wasting the aluminum source and the magnesium source, a layered double hydroxide can be produced advantageously in terms of material balance.

The acid contained in the acidic solution is not particularly limited as long as it makes an aqueous solution acidic, and it is possible to use nitric acid or hydrochloric acid, for example.

Next, the acidic solution containing aluminum ions and magnesium ions and an alkaline solution containing an alkali are mixed in predetermined proportions. As a result, a layered double hydroxide is generated. Mixing can be performed by a method in which the acidic solution is added to the alkaline solution at once and mixed, or the acidic solution is added dropwise to the alkaline solution. However, other methods are also possible.

Here, the alkali contained in the alkaline solution is not particularly limited as long as it makes an aqueous solution alkaline, and it is possible to use sodium hydroxide or calcium hydroxide, for example. In addition, it is also possible to use sodium carbonate, potassium carbonate, ammonium carbonate, aqueous ammonia, sodium borate, potassium borate, or the like. They may be used alone, and it is also possible to use a combination of two or more kinds. As the alkaline solution, one prepared to pH 8 to 14 may be used, and one prepared to pH 8 to 11 is preferably used.

Incidentally, as the aging time after the completion of mixing of the acidic solution and the alkaline solution is shortened, the growth of crystals can be suppressed, and a layered double hydroxide having a reduced crystallite size or a layered double hydroxide having an increased specific surface area can be produced.

As a method for stopping aging, a method in which after the completion of mixing of the acidic solution and the alkaline solution, the pH of the mixture is reduced to a value at which the crystal growth of the layered double hydroxide stops can be mentioned. For example, in the case of the layered double hydroxide represented by general formula Mg²⁺₁₋ₓAl³⁺ₓ(OH)₂(Aⁿ⁻)_{x/n}mH₂O, the pH may be made 9 or less. Specifically, aging can be stopped by dilution with water within 120 minutes after the completion of mixing of the acidic solution and the alkaline solution, preferably within 60 minutes, and more preferably at the same time. In addition, aging can also be stopped by removing moisture. In order to remove moisture, a suitable separation method for separating moisture from the layered double hydroxide, such as suction filtration or centrifugal separation, may be used. In addition, in order to reliability prevent aging from occurring, it is also possible to wash the layered double hydroxide immediately after the completion of mixing of the acidic solution and the alkaline solution. Incidentally, chlorides such as NaCl generated in the course of synthesis may be contained.

The layered double hydroxide immediately after the removal of moisture as described above is in a gel form. The layered double hydroxide used in the present invention may be in such a gel form or may also be dried into a powder form or a granular form.

The layered double hydroxide made into a granular form, that is, granules, may be produced by the following method, for example.

First, to the layered double hydroxide generated as described above, a predetermined pressure, such as a pressure of 0.9 MPa or more, is applied using a dehydrator such as a filter press, thereby removing moisture as much as possible. Next, drying is performed at a temperature equal to or lower than the dehydration temperature of the crystal water of the layered double hydroxide. In other words, only water outside crystals of the layered double hydroxide is dried. Specifically, a layered double hydroxide whose moisture content has been reduced to 70% or less, preferably 65% or less, and still more preferably 60% or less by applying a pressure of 0.9 MPa or more is dried so that the moisture content of granules of the layered double hydroxide, which are the end product, will be 10% or more and 20% or less, preferably 10% or more and 15% or less, and still more preferably 11% or more and 12% or less. Here, the reason why the moisture content of the granules of the layered double hydroxide is maintained at 10% or more is that when the moisture content of the granules of the layered double hydroxide is less than 10%, upon contact with a solution or the like, the granules of the layered double hydroxide rapidly absorb moisture and expand in volume, making it impossible to maintain the particle size. Incidentally, a moisture content is the mass of water relative to the mass of the entire layered double hydroxide including moisture. The mass of moisture contained in the layered double hydroxide was measured in accordance with Japanese Industrial Standard, “Test Method For Water Content Of Soils” (JIS A 1203:1999).

Incidentally, the drying temperature may be any temperature as long as it is equal to or lower than the dehydration temperature of the crystal water of the layered double hydroxide. However, in order to increase the particle size of the granules of the layered double hydroxide, drying is preferably performed at a relatively low temperature. However, when the temperature of drying is too low, the granules of the layered double hydroxide are easily dissolved in water. Therefore, specifically, the favorable drying temperature is 25° C. or more and 125° C. or less, preferably 90° C. or more and 110° C. or less, and still more preferably 95° C. or more and 105° C. or less.

In addition, this drying may be performed in any manner. For example, an ordinary drying furnace or the like may be used. Needless to say, natural drying at room temperature is also possible. In addition, in terms of the form stability of the granules of the layered double hydroxide, it is preferable that the humidity at the time of drying is controlled high. For example, the amount of water vapor in the drying furnace may be controlled to be near the saturated water vapor amount (humidity of 90% to 100%).

In addition, it is also possible that the granules of the layered double hydroxide thus dried are sieved, and the deposited chloride or the like is removed.

In addition, the particle size of the granules of the layered double hydroxide may be adjusted according to the intended use of the filtration body or its kind. In this case, the favorable particle size of the granules of the layered double hydroxide is 0.24 mm or more, for example, preferably 0.36 mm or more, and still more preferably 1 mm or more and 2 mm or less. The adjustment of the particle size may be performed in any manner. For example, it is possible that the granules are crushed with a hammer or the like and sieved through a mesh of a desired size.

Next, the thermally fusible fiber used in the filtration body of the present invention will be described.

The thermally fusible fiber used in the filtration body of the present invention is not particularly limited at long as it is a fiber that can be fused by heating, but is preferably a two-layer conjugate fiber formed of a high-melting-point fiber coated with a low-melting-point fiber. For example, it is possible to use a fiber in which a polyolefin-based fiber or an EVA-based fiber having a relatively low melting point coats a core composed of a fiber having a higher melting point. Accordingly, the layered double hydroxide can be attached by heating to a temperature at which only the low-melting-point surface layer is fused. As a result, the shape of the carrier can be maintained.

The shape of the carrier used in the filtration body of the present invention is not particularly limited, but it is preferable that the carrier is in the form of short cut pieces or reticulated.

In the case where the carrier is in the form of short cut pieces, short cut pieces having attached thereto the layered double hydroxide are intricately attached and connected to each other through the surface of the thermally fusible fiber as a binder. As a result, fine communicating hollow spaces are formed between short cut pieces. Accordingly, the layered double hydroxide can be prevented from locally concentrating to cause clogging. In addition, the proportion occupied by the communicating hollow spaces in the filtration body can be easily changed with the degree of pressure application at the time of molding. Therefore, according to the intended use, filtration bodies having different air permeabilities and water permeabilities can be obtained.

A filtration body using a carrier in the form of short cut pieces can be produced as follows, for example. First, a layered double hydroxide and a carrier in the form of short cut pieces are mixed and loaded into a molding die under vibration. Next, heating is performed to a temperature at which only the surface of the thermally fusible fiber is fused, thereby attaching the layered double hydroxide to the carrier and also attaching and connecting carriers to each other, followed by drying.

In the case where the carrier is reticulated, a filtration body in which the layered double hydroxide is uniformly distributed on the reticulated carrier composed of a thermally fusible fiber as a constituent yarn can be obtained.

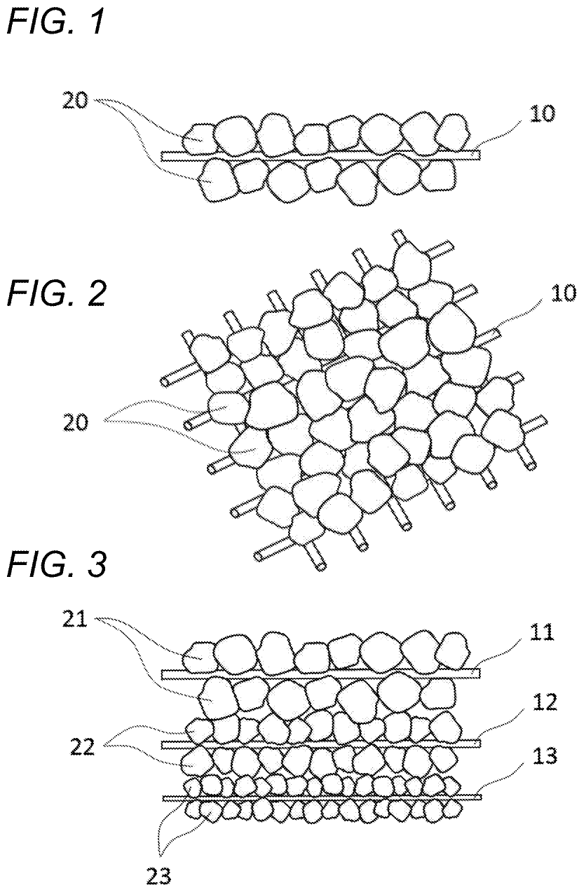

A filtration body using a reticulated carrier can be produced as follows, for example. First, a reticulated carrier 10 composed of a two-layer conjugate fiber as a constituent yarn, in which a high-melting-point chemical fiber is coated with a low-melting-point surface layer of the same series, is prepared. Next, the reticulated carrier 10 is heated to a temperature at which only the low-melting-point surface layer is fused, and passed through a vibration tank containing layered double hydroxide granules 20 of a predetermined size, thereby attaching the layered double hydroxide granules 20 thereto. Next, drying is performed, and granules of the layered double hydroxide that are not fixed through such drying are shaken off. As a result, a filtration body having the layered double hydroxide granules 20 attached to each side of the reticulated carrier 10 is accomplished. FIG. 1 shows a partial side view enlarging and showing a part of the filtration body of the present invention produced by the method described above. In addition, in FIG. 2 shows a partial perspective view enlarging and showing a part of the filtration body.

In addition, the filtration body using a reticulated carrier can also be produced as follows. First, layered double hydroxide granules 20 are mounted on a reticulated carrier 10. At this time, the layered double hydroxide granules 20 at least contain granules that cannot pass the mesh of the reticulated carrier 10. Next, a low-melting-point surface layer of the reticulated carrier 10 is thermally fused to attach the mounted layered double hydroxide granules 20 to the reticulated carrier 10. Next, cooling is performed to fix the granules, and granules of the layered double hydroxide that are not attached are shaken off. As a result, a filtration body in which at least a layered double hydroxide granule 20 that cannot pass through the mesh is attached to one side (upper surface) of the reticulated carrier 10 is accomplished.

In addition, the filtration body of the present invention may also be configured such that a plurality of kinds of carriers having different mesh sizes, each having a layered double hydroxide carried thereon, are sequentially laminated in such a manner that a carrier having a larger mesh size is placed in an upper part. As a result, a filtration body which has low filtration resistance and is particularly suitable for deep bed filtration can be obtained.

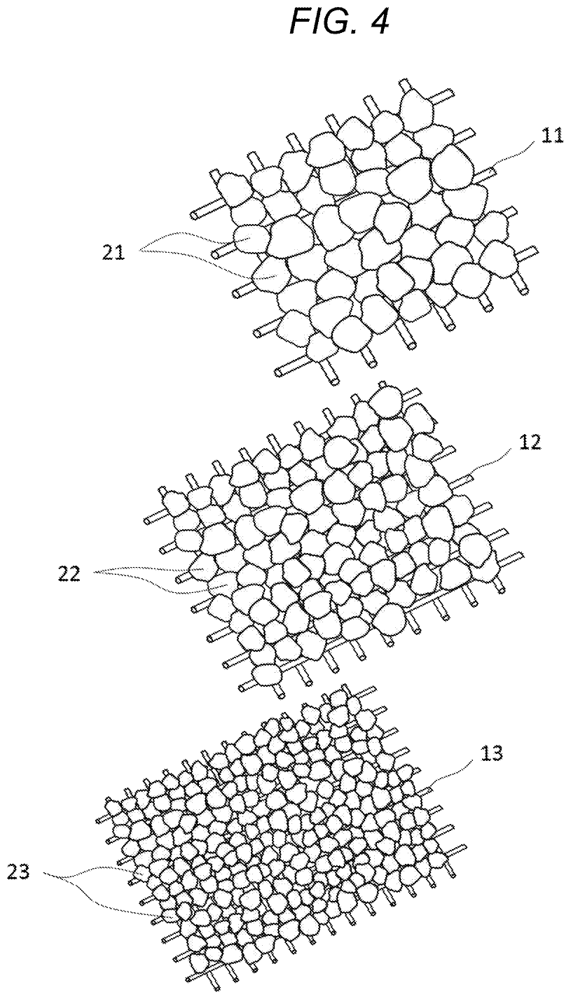

The filtration body configured such that a plurality of kinds of carriers having different mesh sizes, each having a layered double hydroxide carried thereon, can be produced as follows, for example. First, a plurality of kinds of reticulated carriers 10 having different mesh sizes are prepared (e.g. three kinds of reticulated carriers, a reticulated carrier 11 having a mesh of 4×4 mm, a reticulated carrier 12 having a mesh of 3×3 mm, and a reticulated carrier 13 having a mesh of 2×2 mm, are prepared). Next, each carrier is heated to a temperature at which only a low-melting-point surface layer is fused, and passed through a vibration tank containing layered double hydroxide granules 20 of a predetermined size, thereby attaching layered double hydroxide granules 20 having a particle size smaller than the mesh of the carrier (e.g., layered double hydroxide granules 21 having an average particle size of 3 mm are attached to a 4×4 mm-mesh carrier, layered double hydroxide granules 22 having an average particle size of 2 mm to a 3×3 mm-mesh carrier, and layered double hydroxide granules 23 having an average particle size of 1.5 mm to a 2×2 mm-mesh carrier). Next, drying is performed, and layered double hydroxide granules 20 that are not attached through such drying are shaken off. Finally, the filtration bodies thus obtained are sequentially laminated in such a manner that a filtration body having a larger mesh size is placed in an upper part. FIG. 3 shows a partial side view enlarging and showing a part of the filtration body of the present invention produced by the method described above. In addition, in FIG. 4 shows a partial decomposed perspective view enlarging and showing a part of the filtration body.

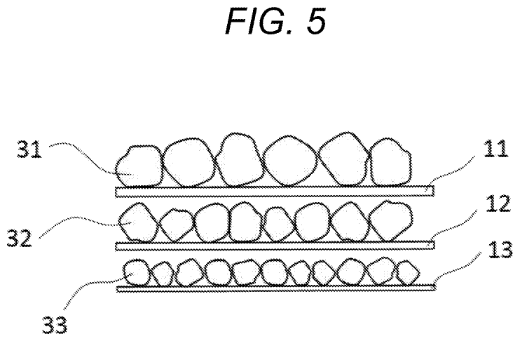

In addition, the filtration body configured such that a plurality of kinds of carriers having different mesh sizes, each having a layered double hydroxide carried thereon, can also be produced as follows. First, a plurality of kinds of reticulated carriers having different mesh sizes are prepared (e.g. three kinds of reticulated carriers, a reticulated carrier 11 having a mesh of 4×4 mm, a reticulated carrier 12 having a mesh of 3×3 mm, and a reticulated carrier 13 having a mesh of 2×2 mm, are prepared). Next, the carriers are sequentially laminated in such a manner that a carrier having a larger mesh size is placed in an upper part, and the carriers are connected to each other. Next, a layered double hydroxide is supplied to an uppermost part of the reticulated carriers, in which the carriers are laminated and connected to each other, (e.g., reticulated carrier 11). At this time, granules of the layered double hydroxide at least contain granules that cannot pass the mesh of each reticulated carrier 10 (e.g., the layered double hydroxide granules are a mixture containing at least layered double hydroxide granules 31 that cannot pass the mesh of the reticulated carrier 11, layered double hydroxide granules 32 that cannot pass the mesh of the reticulated carrier 12, and layered double hydroxide granules 33 that cannot pass the mesh of the reticulated carrier 13). Next, the reticulated carrier is shaken. As a result, of the layered double hydroxide granules 20, a layered double hydroxide that can pass the mesh of each reticulated carrier is shaken off to a lower part of the reticulated carriers, resulting in a state where layered double hydroxide granules are mounted on each reticulated carrier (e.g., a state where at least layered double hydroxide granules 31 are mounted on the reticulated carrier 11, at least layered double hydroxide granules 32 are mounted on the reticulated carrier 12, and at least layered double hydroxide granules 33 are mounted on the reticulated carrier 13). After the reticulated carriers are shaken until layered double hydroxide granules (e.g., layered double hydroxide granules 33) are mounted on the lowermost part of the reticulated carriers (e.g., reticulated carrier 13), low-melting-point surface layers of the reticulated carriers are thermally fused to attach the mounted layered double hydroxide granules to each reticulated carrier. Next, cooling is performed to fix the granules, and granules of the layered double hydroxide that are not attached are shaken off. FIG. 5 shows a partial side view enlarging and showing a part of the filtration body of the present invention produced by the method described above.

### EXAMPLES

Hereinafter, the layered double hydroxide used in the filtration body of the present invention will be described. However, the present invention is not limited to these examples.

### Example 1 (Specific Surface Area)

Four kinds of layered double hydroxides 1 to 4 produced by different methods were prepared, and each specific surface area was measured. In the measurement of the specific surface area, nitrogen gas was adsorbed onto the powder particle surface of each layered double hydroxide at a liquid nitrogen temperature (−196° C.), and the specific surface area was calculated from its amount by the BET method. The results are shown in Table 1.

TABLE 1

| | BET specific surface area (m²/g) |
|---|---|
| Layered double hydroxide 1 | 18.2 |
| Layered double hydroxide 2 | 70.1 |
| Layered double hydroxide 3 | 50.3 |
| Layered double hydroxide 4 | 30.2 |

Incidentally, the details of each layered double hydroxide 1 to 4 are as follows.

(1) Layered Double Hydroxide 1

A layered double hydroxide manufactured by Wako Pure Chemical Industries, Ltd., (distributor code: 324-87435) was used as the layered double hydroxide 1.

(2) Layered Double Hydroxide 2

First, 16.92 g of magnesium chloride hexahydrate (manufactured by Wako Pure Chemical Industries, Ltd.) and 10.06 g of aluminum chloride hexahydrate (manufactured by Wako Pure Chemical Industries, Ltd.) are dissolved in 26.98 g of distilled water to prepare an acidic solution. In addition, 10 g of sodium hydroxide (manufactured by Wako Pure Chemical Industries, Ltd.) is dissolved in 30 g of distilled water to prepare an alkaline solution. Subsequently, the acidic solution and the alkaline solution were mixed, and, without an interval, 281.85 g of distilled water was immediately added to the mixed solution to adjust the pH to 7.5 to 8.5. Then, after 24 hours, the solution was filtered, and the obtained filtrate was dried at 120° C. for 10 hours to give the layered double hydroxide 2.

(3) Layered Double Hydroxide 3

First, 16.92 g of magnesium chloride hexahydrate (manufactured by Wako Pure Chemical Industries, Ltd.) and 10.06 g of aluminum chloride hexahydrate (manufactured by Wako Pure Chemical Industries, Ltd.) are dissolved in 26.98 g of distilled water to prepare an acidic solution. In addition, 10 g of sodium hydroxide (manufactured by Wako Pure Chemical Industries, Ltd.) is dissolved in 30 g of distilled water to prepare an alkaline solution. Subsequently, the acidic solution and the alkaline solution were mixed. Without an interval, 281.85 g of distilled water was immediately added to the mixed solution, and then an aqueous sodium hydroxide solution was added to adjust the pH to 10.0. Then, after 24 hours, the solution was filtered, and the obtained filtrate was dried at 120° C. for 10 hours to give the layered double hydroxide 3.

(4) Layered Double Hydroxide 4

First, 16.92 g of magnesium chloride hexahydrate (manufactured by Wako Pure Chemical Industries, Ltd.) and 10.06 g of aluminum chloride hexahydrate (manufactured by Wako Pure Chemical Industries, Ltd.) are dissolved in 26.98 g of distilled water to prepare an acidic solution. In addition, 10 g of sodium hydroxide (manufactured by Wako Pure Chemical Industries, Ltd.) is dissolved in 30 g of distilled water to prepare an alkaline solution. Subsequently, the acidic solution and the alkaline solution were mixed. Without an interval, 281.85 g of distilled water was immediately added to the mixed solution, and then an aqueous sodium hydroxide solution was added to adjust the pH to 12.0. Then, after 24 hours, the solution was filtered, and the obtained filtrate was dried at 120° C. for 10 hours to give the layered double hydroxide 4.

The list of reference numbers used in the drawing figures is as follows:
10 Reticulated carrier
11 Reticulated carrier
12 Reticulated carrier
13 Reticulated carrier
20 Layered double hydroxide granule
21 Layered double hydroxide granule
22 Layered double hydroxide granule
23 Layered double hydroxide granule
31 Layered double hydroxide granule
32 Layered double hydroxide granule
33 Layered double hydroxide granule

1. A filtration body comprising a layered double hydroxide having a crystallite size of 20 nm or less carried on a carrier including a thermally fusible fiber.

2. The filtration body according to claim 1, wherein the thermally fusible fiber is a two-layer conjugate fiber formed of a high-melting-point fiber coated with a low-melting-point fiber.

3. The filtration body according to claim 1, wherein the carrier including a thermally fusible fiber is in a form of short cut pieces.

4. The filtration body according to claim 1, wherein the carrier including a thermally fusible fiber is reticulated.

5. The filtration body according to claim 4, wherein the reticulated carrier has carried thereon a layered double hydroxide that cannot pass through a mesh thereof.

6. The filtration body according to claim 1, wherein the layered double hydroxide has a specific surface area of 20 m²/g or more.

7. The filtration body according to claim 1, wherein the layered double hydroxide has a specific surface area of 70 m²/g or more.

8. The filtration body according to claim 1, wherein the layered double hydroxide is in a form of granules produced by applying a predetermined pressure to a material containing a layered double hydroxide and water to remove moisture to a moisture content of 70% or less, followed by drying under conditions having a temperature of 90° C. or more and 110° C. or less.

9. A method for producing a filtration body formed of a layered double hydroxide carried on a reticulated carrier including a thermally fusible fiber, the method for producing a filtration body comprising:
a mounting step of mounting a layered double hydroxide on the reticulated carrier; and
after the mounting step, an attaching step of attaching the mounted layered double hydroxide to the reticulated carrier by thermally fusing the thermally fusible fiber.

10. The method for producing a filtration body according to claim 9, wherein
the reticulated carrier is obtained by sequentially laminating a plurality of kinds of carriers having different mesh sizes in such a manner that a carrier having a larger mesh size is placed in an upper part, and
in the mounting step, a layered double hydroxide is supplied to an uppermost part of the laminated reticulated carriers, and the reticulated carriers are shaken until the layered double hydroxide is mounted on a lowermost part of the reticulated carriers.

11. The filtration body according to claim 2, wherein the carrier including a thermally fusible fiber is in a form of short cut pieces.

12. The filtration body according to claim 2, wherein the carrier including a thermally fusible fiber is reticulated.

13. The filtration body according to claim 12, wherein the reticulated carrier has carried thereon a layered double hydroxide that cannot pass through a mesh thereof.

14. The filtration body according to claim 2, wherein the layered double hydroxide has a specific surface area of 20 m²/g or more.

15. The filtration body according to claim 2, wherein the layered double hydroxide has a specific surface area of 70 m²/g or more.

16. The filtration body according to claim 2, wherein the layered double hydroxide is in a form of granules produced by applying a predetermined pressure to a material containing a layered double hydroxide and water to remove moisture to a moisture content of 70% or less, followed by drying under conditions having a temperature of 90° C. or more and 110° C. or less.

17. The filtration body according to claim 3, wherein the layered double hydroxide has a specific surface area of 20 m²/g or more.

18. The filtration body according to claim 3, wherein the layered double hydroxide has a specific surface area of 70 m²/g or more.

19. The filtration body according to claim 3, wherein the layered double hydroxide is in a form of granules produced by applying a predetermined pressure to a material containing a layered double hydroxide and water to remove moisture to a moisture content of 70% or less, followed by drying under conditions having a temperature of 90° C. or more and 110° C. or less.

20. The filtration body according to claim 4, wherein the layered double hydroxide has a specific surface area of 20 m²/g or more.
